(19) United States
(12) Patent Application Publication
(10) Pub. No.: US 2016/0360496 A1
(43) Pub. Date: Dec. 8, 2016

(54) FREQUENCY BANDWIDTH AND CHANNEL DEPENDENT TRANSMITTING POWER FOR LTE DEVICES

(71) Applicant: APPLE INC., Cupertino, CA (US)

(72) Inventors: Abhishek A. Mehta, Milpitas, CA (US); Jianjian Li, San Jose, CA (US); Kaushal K. Mangtani, San Jose, CA (US); Manjit S. Walia, San Jose, CA (US); Mohit Narang, San Jose, CA (US); Peter M. Agboh, San Francisco, CA (US); Rahul A. Sabnani, Sunnyvale, CA (US); Shrenik Milapchand, Fremont, CA (US); Vikas O. Jain, San Jose, CA (US)

(21) Appl. No.: 14/732,080

(22) Filed: Jun. 5, 2015

(51) Int. Cl. H04W 52/28; H04W 72/04

(52) U.S. Cl. CPC H04W 52/283; H04W 72/0453; H04W 52/0209

(57) ABSTRACT

Methods and devices for reducing the power consumption and increasing the efficiency of an LTE transmitter of an electronic device are provided. By way of example, a method includes calculating location data related to a region in which the electronic device may operate via the electronic device, determining via the electronic device a region in which the electronic device is currently operating within based on the location data, and adjusting an output transmitting power of the electronic device based at least in part on the region and one or more frequency operating parameters utilized by the electronic device.

### BACKGROUND

The present disclosure relates generally to Long Term Evolution (LTE) devices, and more particularly, to frequency bandwidth and channel dependent transmitting power for LTE devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Transmitters and receivers are commonly included in various electronic devices, and particularly, portable electronic devices such as, for examples, phones (e.g., mobile and cellular phones, cordless phones, personal assistance devices), computers (e.g., laptops, tablet computers), internet connectivity routers (e.g., Wi-Fi routers or modems), radios, televisions, or any of various other stationary or handheld devices. One type of transmitter, known as a wireless transmitter, may be used to generate a wireless signal to be transmitted by way of an antenna coupled to the transmitter. Specifically, the wireless transmitter is generally used to wirelessly communicate data over a network channel or other medium (e.g., air) to one or more receiving devices.

Long Term Evolution (LTE) is a standard for wireless data communication or the network through which the data is communicated, and may involve the use of certain LTE transmitters within electronic devices. An LTE standard network may provide the advantages of a high data rate and relatively low latency and delay. An LTE standard network may also support various carrier bandwidths that may range, for example, from 1.4 megahertz (MHz) up to 20 MHz. Most generally, the carrier bandwidth that is utilized by an LTE transmitter of an electronic device may be based upon the frequency band and the amount of frequency spectrum available from an LTE network provider or within a given LTE coverage region. Indeed, during operation, the LTE transmitter of the electronic device may transmit at a constant output transmitting power for all of the carrier bandwidths respective of only the different LTE coverage regions. However, by allowing an LTE transmitter to transmit at a constant maximum output transmitting power, the LTE transmitter, and, by extension, the electronic device encompassing the LTE transmitter may be subject to unnecessary power consumption, and may thus decrease the overall battery life and efficiency of the electronic device. It may be useful to provide more advanced and improved LTE transmitters and devices.

### SUMMARY

Certain aspects commensurate with certain disclosed embodiments are set forth below. It should be understood that these aspects are presented merely to provide the reader with a brief summary of the disclosure and that these aspects are not intended to limit the scope of the disclosure or the claims. Indeed, the disclosure and claims may encompass a variety of aspects that may not be set forth below.

Methods and devices for reducing the power consumption and increasing the efficiency of an LTE transmitter of an electronic device are provided. By way of example, a method includes calculating location data related to a region in which the electronic device may operate via the electronic device, determining via the electronic device a region in which the electronic device is currently operating within based on the location data, and adjusting an output transmitting power of the electronic device based at least in part on the region and one or more frequency operating parameters utilized by the electronic device.

### BRIEF DESCRIPTION OF THE DRAWINGS

Advantages of the disclosure may become apparent upon reading the following detailed description and upon reference to the drawings in which:

FIG. 1 is a schematic block diagram of an electronic device including a transceiver, in accordance with an embodiment;

FIG. 2 is a perspective view of a notebook computer representing an embodiment of the electronic device of FIG. 1, in accordance with an embodiment;

FIG. 3 is a front view of a hand-held device representing another embodiment of the electronic device of FIG. 1, in accordance with an embodiment;

FIG. 4 is a front view of another hand-held device representing another embodiment of the electronic device of FIG. 1, in accordance with an embodiment;

FIG. 5 is a schematic diagram of a transmitter as part of the transceiver included within the electronic device of FIG. 1, in accordance with an embodiment;

FIG. 6 is a table diagram of the output transmitting power of the transmitter of FIG. 5 for different regions, in accordance with an embodiment;

FIG. 7 is a table diagram of the frequency bandwidth and frequency channel dependent output transmitting power of the transmitter of FIG. 5 for different regions, in accordance with an embodiment; and

FIG. 8 is a flow diagram illustrating an embodiment of a process useful in reducing the power consumption and increasing the efficiency of an LTE transmitter, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to methods and devices for reducing the power consumption and increasing the efficiency of Long Term Evolution (LTE) transceivers (e.g., transmitters) within electronic devices. In certain embodiments, an LTE transmitter may include a processor used to adjust or vary the output transmitting power of the LTE transmitter based on, for example, the particular frequency carrier bandwidth and/or a particular frequency channel and the region (e.g., continent, country, territory, and so forth) in which the electronic device is currently operating. In this way, the power consumption of the LTE transmitter, and, by extension, the electronic device encompassing the LTE transmitter may be reduced, and, further, the efficiency and data throughput of the electronic device may be increased. That is, instead of providing a constant maximum output transmitting power across an entire frequency band (e.g., LTE frequency band) for a given coverage region and across all LTE frequency carrier bandwidths and frequency channels, the present techniques may adjust or vary the output transmitting power (e.g., maximum output transmitting power) based on, for example, the specific carrier bandwidth and/or frequency channels within an LTE frequency band for a given coverage region. As used herein, “region” may refer to a wireless coverage area or network, or, more specifically, the wireless coverage area or network designated for or by various continents, countries, territories, and so forth. Similarly, “region” may refer to the frequency band(s) for the wireless coverage area or network designated for or by the various continents, countries, territories, and so forth.

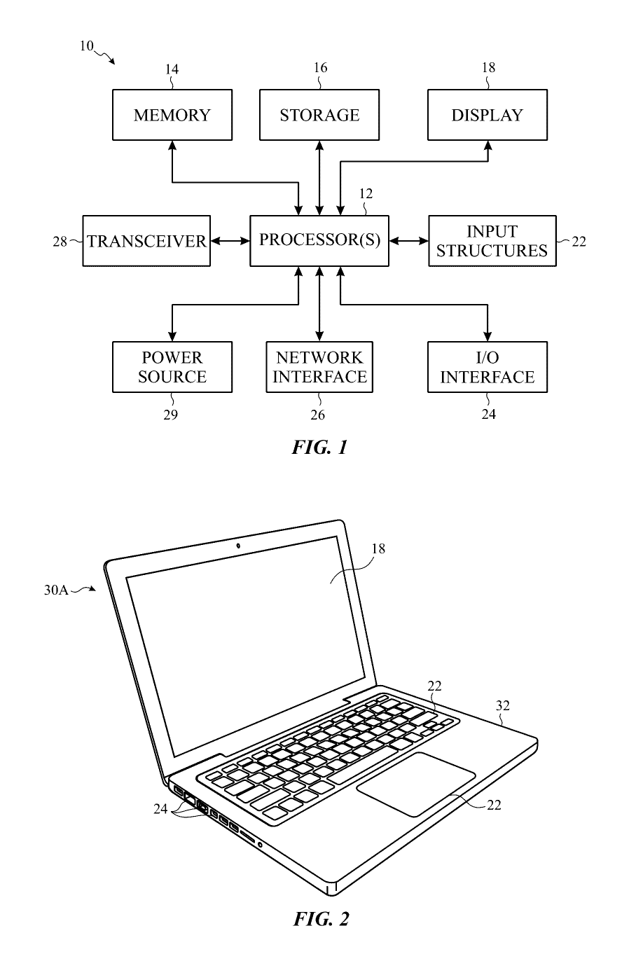

With the foregoing in mind, a general description of suitable electronic devices that may be useful in reducing the power consumption (e.g., increasing battery life) and increasing the efficiency of an LTE transmitter of an electronic device is provided. Turning first to FIG. 1, an electronic device 10 according to an embodiment of the present disclosure may include, among other things, one or more processor(s) 12, memory 14, nonvolatile storage 16, a display 18, input structures 22, an input/output (I/O) interface 24, network interfaces 26, a transceiver 28, and a power source 29. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

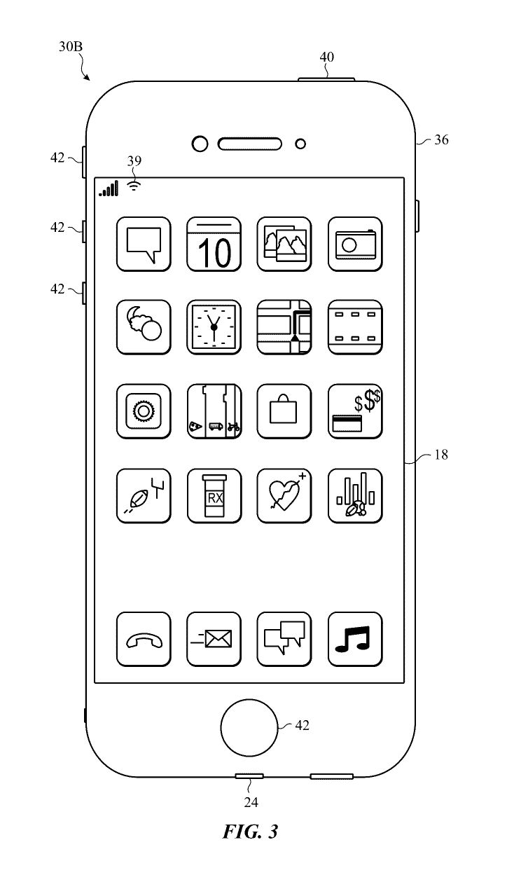

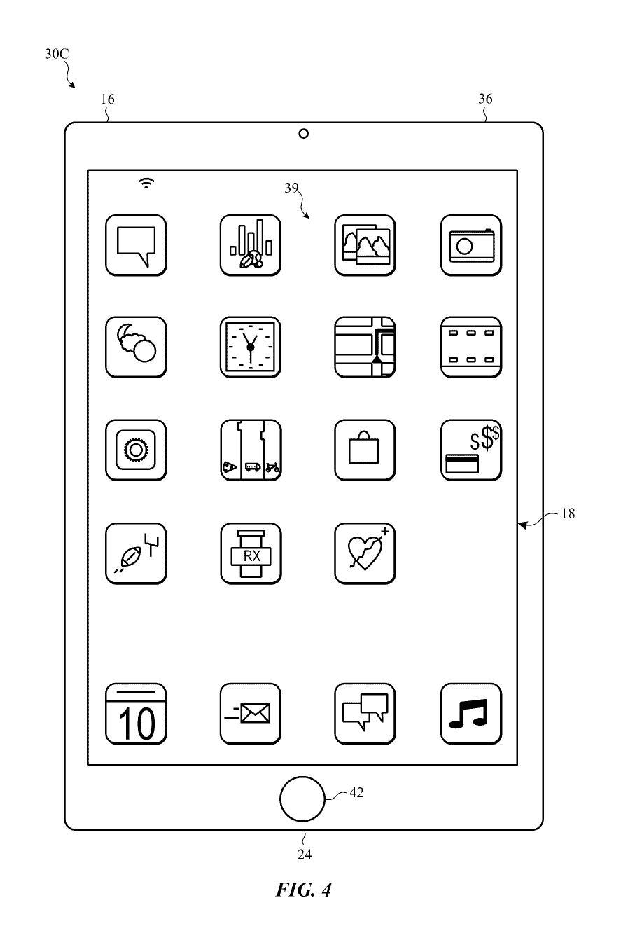

By way of example, the electronic device 10 may represent a block diagram of the notebook computer depicted in FIG. 2, the handheld device depicted in FIG. 3, the desktop computer depicted in FIG. 4, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile memory 16 to perform various algorithms. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions that may be executed by the processor(s) 12 to enable the electronic device 10 to provide various functionalities.

In certain embodiments, the display 18 may be a liquid crystal display (LCD), which may allow users to view images generated on the electronic device 10. In some embodiments, the display 18 may include a touch screen, which may allow users to interact with a user interface of the electronic device 10. Furthermore, it should be appreciated that, in some embodiments, the display 18 may include one or more organic light emitting diode (OLED) displays, or some combination of LCD panels and OLED panels.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN) or wireless local area network (WLAN), such as an 802.11x Wi-Fi network, and/or for a wide area network (WAN), such as a 3^{rd} generation (3G) cellular network, 4^{th} generation (4G) cellular network, or Long Term Evolution (LTE) cellular network. The network interface 26 may also include interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra Wideband (UWB), alternating current (AC) power lines, and so forth.

In certain embodiments, to allow the electronic device 10 to communicate over the aforementioned wireless networks (e.g., Wi-Fi, WiMAX, Mobil WiMAX, 4G, LTE, and so forth) facilitated by the network interface 26, the electronic device 10 may include a transceiver 28. The transceiver 28 may include any circuitry the may be useful in both wirelessly receiving and wirelessly transmitting signals (e.g., data signals). Indeed, in some embodiments, as will be further appreciated, the transceiver 28 may include an LTE transmitter and an LTE receiver combined into a single unit, or, in other embodiments, the transceiver 28 may include a transmitter separate from a receiver.

For example, as noted above, the transceiver 28 may transmit and receive signals (e.g., data symbols) to support data communication in wireless applications such as, for example, PAN networks (e.g., Bluetooth), WLAN networks (e.g., 802.11x Wi-Fi), WAN networks (e.g., 3G, 4G, and LTE cellular networks), WiMAX networks, mobile WiMAX networks, ADSL and VDSL networks, DVB-T and DVB-H networks, UWB networks, and so forth. As further illustrated, the electronic device 10 may include a power source 29. The power source 29 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 30A, is illustrated in FIG. 2 in accordance with one embodiment of the present disclosure. The depicted computer 30A may include a housing or enclosure 32, a display 18, input structures 22, and ports of an I/O interface 24. In one embodiment, the input structures 22 (such as a keyboard and/or touchpad) may be used to interact with the computer 30A, such as to start, control, or operate a GUI or applications running on computer 30A. For example, a keyboard and/or touchpad may allow a user to navigate a user interface or application interface displayed on display 18.

FIG. 3 depicts a front view of a handheld device 30B, which represents one embodiment of the electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif.

The handheld device 30B may include an enclosure 36 to protect interior components from physical damage and to shield them from electromagnetic interference. The enclosure 36 may surround the display 18, which may display indicator icons 39. The indicator icons 38 may indicate, among other things, a cellular signal strength, Bluetooth connection, and/or battery life. The I/O interfaces 24 may open through the enclosure 36 and may include, for example, an I/O port for a hard wired connection for charging and/or content manipulation using a standard connector and protocol, such as the Lightning connector provided by Apple Inc., a universal service bus (USB), or other similar connector and protocol.

User input structures 42, in combination with the display 18, may allow a user to control the handheld device 30B. For example, the input structure 40 may activate or deactivate the handheld device 30B, the input structure 42 may navigate user interface to a home screen, a user-configurable application screen, and/or activate a voice-recognition feature of the handheld device 30B, the input structures 42 may provide volume control, or may toggle between vibrate and ring modes. The input structures 42 may also include a microphone may obtain a user's voice for various voice-related features, and a speaker may enable audio playback and/or certain phone capabilities. The input structures 42 may also include a headphone input may provide a connection to external speakers and/or headphones.

FIG. 4 depicts a front view of another handheld device 30C, which represents another embodiment of the electronic device 10. The handheld device 30C may represent, for example, a tablet computer, or one of various portable computing devices. By way of example, the handheld device 30C may be a tablet-sized embodiment of the electronic device 10, which may be, for example, a model of an iPad® available from Apple Inc. of Cupertino, Calif.

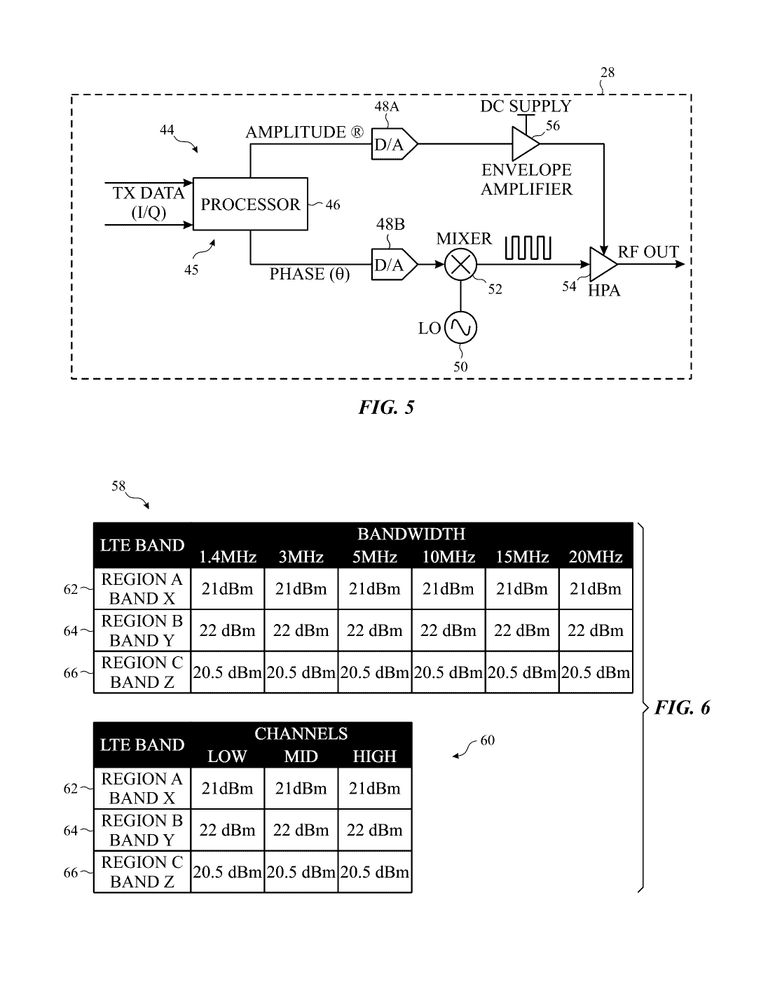

In certain embodiments, as previously noted above, each embodiment (e.g., notebook computer 30A, handheld device 30B, and handheld device 30C) of the electronic device 10 may include a transceiver 28, which may include a transmitter (e.g., transmitter 44 as will be discussed below with respect to FIG. 5). Indeed, as will be further appreciated, the transmitter may include one or more processors (e.g., digital signal processor (DSP), coordinate rotation digital computer (CORDIC) processor) that may be used to cause the transmitter to generate an electromagnetic signal (e.g., LTE carrier signal) at an output transmitting power that varies based on, for example, the frequency carrier bandwidth and/or the frequency channel and the region (e.g., continent, country, territory, and so forth) in which the electronic device 10 is currently operating. That is, instead of providing a constant maximum output transmitting power across an entire frequency band (e.g., LTE frequency band) for a given region and across all LTE frequency carrier bandwidths and frequency channels, the present techniques may adjust or vary the output transmitting power (e.g., maximum output transmitting power) based on, for example, the specific bandwidth and/or frequency channels within an LTE frequency band for a given region. In this way, the power consumption of the LTE transmitter, and, by extension, the electronic device 10 may be reduced, and, further, the efficiency and data throughput of the electronic device 10 may be increased.

With the foregoing in mind, FIG. 5 depicts a transmitter 44 that may be included as part of the transceiver 28. Although not illustrated, it should be appreciated that the transceiver 28 may also include a receiver that may be coupled to the transmitter 44. As depicted, the transmitter 44 may receive a signal 45 that may be modulated via a processor 46. In certain embodiments, the transmitter 44 may receive a Cartesian coordinate represented signal 45, which may include, for example, data symbols encoded according to orthogonal in-phase (I) and quadrature (Q) vectors. Thus, when an I/Q signal is converted into an electromagnetic wave (e.g., radio frequency (RF) signal, microwave signal, millimeter wave signal), the conversion is generally linear as the I/Q maybe frequency band-limited.

As further depicted in FIG. 5, the transmitter 44 may also include digital-to-analog converters (DACs) 48A and 48B that may be used to convert (e.g., sample) the polar amplitude component and the phase component of the signal 45 into digital signal components. As further illustrated, the phase component signal may be then passed to a mixer 52, which may be used to mix (e.g., upconvert or downconvert) the frequency of the polar phase component signal with the frequency of a local oscillator (LO) 50 to generate, for example, a radio frequency (RF) signal for transmission. In one embodiment, the polar amplitude component signal may be passed through an amplifier 56 (e.g., envelop amplifier) that may be used to track and adjust the envelope of the polar amplitude component signal. Lastly, the polar amplitude component signal and the polar phase component signal may be each passed to a high power amplifier (HPA) 54 to generate an electromagnetic signal (e.g., radio frequency (RF) signal, microwave signal, millimeter wave signal) at the RF frequency to transmit (e.g., via an antenna coupled to the transmitter 44).

In certain embodiments, as previously discussed, the processor 46 in conjunction with the HPA 54 of the transmitter 44 may be used, for example, to support the LTE wireless communication standard. Indeed, in certain embodiments, the processor 46 may control the output transmitting power of the HPA 54 (e.g., the power magnitude at the output of the HPA 54) based on, for example, the region (e.g., continent, country, territory, and so forth) in which the electronic device 10 is located. Specifically, in the LTE embodiment of the electronic device 10, the transmitter 44 may be used to establish wireless service (e.g., telecommunications service such as telephone service and internet service) over various LTE frequency carrier bandwidths ranging between, for example, 1.4 megahertz (MHz), 3 MHz, 5 MHz, 10 MHz, 15 MHz, and up to 20 MHz. In certain embodiments, the bandwidth utilized by the transmitter 44 may be based on, for example, frequency band and the amount of frequency spectrum that may be available in the region (e.g., continent, country, territory, and so forth) in which the electronic device 10 is located. It should be appreciated that a given region may be detected by the electronic device 10 based on, for example, GPS location data, web-based location data, or other data that may indicate the physical location of the electronic device 10 at any given time.

In some embodiments, each region in which the electronic device 10 may be located may include different LTE frequency bands. For example, the United States, Canada, and Mexico regions may each include frequency bands of, for example, 700 MHz, 750 MHz, 800 MHz, 850 MHz, 1900 MHz, 2500 MHz, and 2600 MHz. Regions of South America may include a single frequency band of, for example, 2500 MHz. Similarly, regions of Europe may include frequency bands of, for example, 700 MHz, 800 MHz, 900 MHz, 1800 MHz, and 2600 MHz. Regions of Asia may include frequency bands of, for example, 1800 MHz and 2600 MHz, while regions of Australia may include frequency bands of, for example, 1800 MHz and 2300 MHz. As may be appreciated, in some embodiments, the different LTE frequency bands corresponding to the various regions in which the electronic device 10 may be located may require that the transmitter 44 transmit at a maximum constant output transmitting power respective of only the different LTE coverage regions. This may lead to increased power consumption by the electronic device 10, and may thus reduce the battery life of the electronic device 10. This may also lead to a reduction in LTE network coverage area for a user of the electronic device 10.

For example, FIG. 6 illustrates table diagrams 58 and 60 depicting the various magnitudes of output transmitting power (e.g., maximum output transmitting power) of the transmitter 44 for various regions and frequency bands 62 (e.g., “Region A”; “Band X”), 64 (e.g., “Region B”; “Band Y”), and 66 (e.g., “Region C”; “Band Z”). Specifically, the table diagram 58 depicts the various magnitudes of output transmitting power of the transmitter 44 for LTE frequency bandwidths 1.4 MHz, 3 MHz, 5 MHz, 10 MHz, 15 MHz, and 20 MHz. In one embodiment, table diagrams 58 and 60 may be representative of a look-up table or other database that may be stored on the transceiver 28 (or on the memory 14) and executed and utilized by the processor 46 and other components of the transmitter 44 to generate an electromagnetic signal (e.g., LTE carrier signal) based thereon. As depicted, the magnitude of the output transmitting power (e.g., maximum output transmitting power) of the transmitter 44 may be based, for example, only on the specific regions and frequency bands 62 (e.g., “Region A”; “Band X”), 64 (e.g., “Region B”; “Band Y”), and 66 (e.g., “Region C”; “Band Z”).

For example, as illustrated by the table diagram 58, the magnitude of the output transmitting power of the transmitter 44 for the region and frequency band 62 (e.g., “Region A”; “Band X”) may be set to, for example, a constant value of 21 decibel-milliwatts (dBm) for each of the LTE frequency bandwidths 1.4 MHz, 3 MHz, 5 MHz, 10 MHz, 15 MHz, and 20 MHz. Likewise, the magnitude of the output transmitting power of the transmitter 44 for the regions and frequency bands 64 (e.g., “Region A”; “Band X”) and 66 (e.g., “Region C”; “Band Z”) may be each set to, for example, constant values of 22 dBm and 20.5 dBm, respectively, for each of the LTE frequency bandwidths 1.4 MHz, 3 MHz, 5 MHz, 10 MHz, 15 MHz, and 20 MHz.

In a similar manner, the table diagram 60 depicts the various magnitudes of output transmitting power (e.g., maximum output transmitting power) of the transmitter 44 for LTE frequency channels (e.g., individual frequency channels corresponding to each of the LTE frequency bandwidths 1.4 MHz, 3 MHz, 5 MHz, 10 MHz, 15 MHz, and 20 MHz generated via frequency division multiplexing [FDM]) designated as “High,” “Mild” and “Low.” As illustrated, the magnitude of the output transmitting power of the transmitter 44 may, again, be based only on the specific regions and frequency bands 62 (e.g., “Region A”; “Band X”), 64 (e.g., “Region B”; “Band Y”), and 66 (e.g., “Region C”; “Band Z”). For example, as illustrated by the table diagram 60, the magnitude of the output transmitting power (e.g., maximum output transmitting power) of the transmitter 44 for the regions and frequency bands 62 (e.g., “Region A”; “Band X”), 64 (e.g., “Region B”; “Band Y”), and 66 (e.g., “Region C”; “Band Z”) may be each set, for example, to the constant values of 21 dBm, 22 dBm, 20.5 dBm for each of the LTE frequency channels “High,” “Mild” and “Low.” However, as previously noted above, by allowing the transmitter 44 to transmit at a constant maximum output power, which varies only for the different regions (e.g., “Region A,” “Region B,” “Region C”), the transmitter 44, and, by extension, the electronic device 10 may consume unnecessary power and thus decrease the battery life and efficiency of the electronic device 10.

Accordingly, in certain embodiments, it may be useful for the processor 46 of the transmitter 44 to cause the transmitter 44 to adjust or vary the output transmitting power (e.g., maximum output transmitting power) based on, for example, the specific frequency carrier bandwidth and/or frequency channels within a frequency band for a given region. Indeed, in one embodiment, when the electronic device 10 is operating on a specific frequency carrier bandwidth or and/or frequency channels within a frequency band for a given region (e.g., in which LTE standard requirements may be difficult to achieve), the processor 46 may cause the transmitter 44 to transmit at an output transmitting power (e.g., maximum output transmitting power) that may vary based on, for example, the frequency carrier bandwidth and/or the frequency channel on which the electronic device 10 is operating to reduce power consumption. Otherwise, the processor 46 may cause the transmitter 44 to transmit at maximum output transmitting power (e.g., when beneficial to do so), and may thus further increase the data throughput of the electronic device 10 while also limiting power consumption.

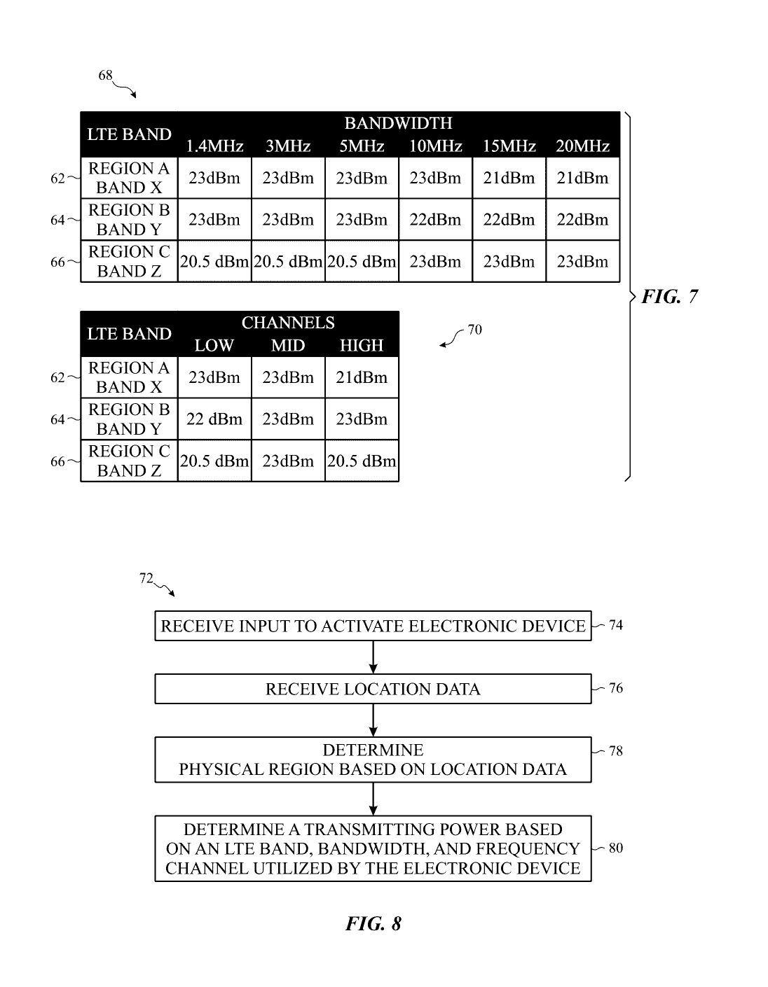

For example, FIG. 7 illustrates table diagrams 68 and 70 depicting the various magnitudes of output transmitting power (e.g., maximum output transmitting power) of the transmitter 44 for various regions and frequency bands 62 (e.g., “Region A”; “Band X”), 64 (e.g., “Region B”; “Band Y”), and 66 (e.g., “Region C”; “Band Z”), in which the output transmitting power varies based on, for example, the frequency carrier bandwidth and/or the frequency channel on which the electronic device 10 is operating. Indeed, the table diagram 68 depicts the various magnitudes of output transmitting power (e.g., maximum output transmitting power) of the transmitter 44 for LTE frequency bandwidths 1.4 MHz, 3 MHz, 5 MHz, 10 MHz, 15 MHz, and 20 MHz. As noted above with respect to FIG. 6, in one embodiment, table diagrams 68 and 70 may be representative of a look-up table or other database that may be stored on the transceiver 28 (or on the memory 14) and executed and utilized by the processor 46 of the transmitter 44 to generate an electromagnetic signal (e.g., LTE carrier signal) at an output transmitting power (e.g., maximum output transmitting power) that varies based on, for example, the frequency carrier bandwidth and/or the frequency channel and the region (e.g., continent, country, territory, and so forth) in which the electronic device 10 is currently operating.

For example, as depicted by the table diagram 68, the magnitude of the output transmitting power (e.g., maximum output transmitting power) of the transmitter 44 may be based on, for example, the specific regions and frequency bands 62 (e.g., “Region A”; “Band X”), 64 (e.g., “Region B”; “Band Y”), and 66 (e.g., “Region C”;

“Band Z”), as well as on the frequency bandwidth and/or the frequency channel on which the electronic device 10 is operating. For example, as illustrated by the table diagram 68, the magnitude of the output transmitting power (e.g., maximum output transmitting power) of the transmitter 44 for the region and frequency band 62 (e.g., “Region A”; “Band X”) may be set to, for example, a value of 23 dBm for the LTE frequency bandwidths of 1.4 MHz, 3 MHz, 5 MHz, and 10 MHz.

On the other hand, for the same region and frequency band 62 (e.g., “Region A”; “Band X”), the magnitude of the output transmitting power of the transmitter 44 may be set to, for example, a value of 21 dBm for the LTE frequency bandwidths of 15 MHz and 20 MHz. Likewise, the magnitude of the output transmitting power of the transmitter 44 for the region and frequency band 64 (e.g., “Region A”; “Band X”) may be set to, for example, a value of 23 dBm for the LTE frequency bandwidths of 1.4 MHz, 3 MHz, and 5 MHz, and may be switched to a value of 22 dBm for the LTE frequency bandwidths of 10 MHz, 15 MHz, and 20 MHz. It should be appreciated the output transmitting power magnitude values are included merely for the purpose of illustration. In an actual implementation of the present techniques, the output transmitting power (e.g., maximum output transmitting power) magnitude values may include any values that vary based on a specific frequency carrier bandwidth and/or frequency channel.

In a similar manner, the table diagram 70 depicts the various magnitudes of output transmitting power (e.g., maximum output transmitting power) of the transmitter 44 for LTE frequency channels designated as “High,” “Mild,” and “Low” as previously discussed with respect to FIG. 6. As illustrated, the magnitude of the output transmitting power of the transmitter 44 may be based on, for example, the specific regions and frequency bands 62 (e.g., “Region A”; “Band X”), 64 (e.g., “Region B”; “Band Y”), and 66 (e.g., “Region C”; “Band Z”), as well as on the specific frequency channel (e.g., “High,” “Mild” and “Low”). For example, as illustrated by the table diagram 70, the magnitude of the output transmitting power of the transmitter 44 for the region and frequency band 62 (e.g., “Region A”; “Band X”) may be set to, for example, a value of 23 dBm for the “Low” and “Mild” frequency channels, and may be switched to 21 dBm for the “High” frequency channel.

Similarly, as further illustrated, the magnitude of the output transmitting power (e.g., maximum output transmitting power) of the transmitter 44 for the region and frequency band 64 (e.g., “Region B”; “Band Y”) may be set to, for example, a value of 22 dBm for the “Low” frequency channel, and may be switched to 23 dBm for the “Mild” and “High” frequency channels, respectively. Lastly, the magnitude of the output transmitting power of the transmitter 44 for the region and frequency band 66 (e.g., “Region C”; “Band Z”) may be set to, for example, a value of 20.5 dBm for the “Low” frequency channel and the “High” frequency channel, while the magnitude of the output transmitting power may be set to, for example, a value of 23 dBm for the “Mild” frequency channel. In these ways, the power consumption of the transmitter 44, and, by extension, the electronic device 10 may be reduced, and, further, the efficiency and data throughput of the electronic device 10 may be increased.

Turning now to FIG. 8, a flow diagram is presented, illustrating an embodiment of a process 72 useful in reducing the power consumption (e.g., increasing battery life) and increasing the efficiency of an LTE transmitter of an electronic device by using, for example, the one or more the processor(s) 12 and/or processor 46 depicted in FIGS. 1 and 5. The process 72 may include code or instructions stored in a non-transitory machine-readable medium (e.g., the memory 14) and executed, for example, by the one or more processor(s) 12 and/or processor 46. The process 72 may begin with the processor(s) 12 and/or processor 46 receiving (block 74) an input to activate an electronic device (e.g., powering up the electronic device 10). The process 72 may continue with the processor(s) 12 and/or processor 46 receiving (block 76) location data. For example, processor(s) 12 and/or processor 46 may receive GPS location data, web-based location data, or other data that may indicate the physical location of the electronic device 10 at any given time.

The process 72 may then continue with the processor(s) 12 and/or processor 46 determining (block 78) a physical region in which the electronic device 10 is located based on the location data. For example, as previously discussed above, each region in which the electronic device 10 may be located may include different LTE frequency bands. For example, the United States, Canada, and Mexico regions may each include frequency bands of, for example, 700 MHz, 750 MHz, 800 MHz, 850 MHz, 1900 MHz, 2500 MHz, and 2600 MHz, while regions of Europe and Asia may include one or more frequency bands of, for example, 700 MHz, 800 MHz, 900 MHz, 1800 MHz, and 2600 MHz.

The process 72 may then conclude with the processor(s) 12 and/or processor 46 causing (block 80) the electronic device to transmit at an output transmitting power based on an LTE frequency band, frequency carrier bandwidth, and/or frequency channel currently utilized by the electronic device. Specifically, as previously noted above with respect to FIG. 7, the processor 46 of the transmitter 44 may cause the transmitter 44 to generate an electromagnetic signal (e.g., LTE carrier signal) at an output transmitting power (e.g., maximum output transmitting power) that varies based on, for example, the frequency carrier bandwidth and/or the frequency channel and the region (e.g., continent, country, territory, and so forth) in which the electronic device 10 is currently operating. In this way, the power consumption of the transmitter 44, and, by extension, the electronic device 10 may be reduced, and, further, the efficiency and data throughput of the electronic device 10 may be increased. That is, instead of providing a constant maximum output transmitting power across an entire frequency band (e.g., LTE frequency band) of a given region and across all LTE frequency bandwidths and frequency channels, the present techniques may adjust or vary the output transmitting power (e.g., maximum output transmitting power) based on, for example, the specific frequency carrier bandwidth and/or frequency channels within a frequency band of a given region.

While the various embodiments may be susceptible to various modifications and alternative forms, specific embodiments have been shown by way of example in the drawings and have been described in detail herein. However, it should be understood that the claims are not intended to be limited to the particular forms disclosed. Rather, the claims are to cover all modifications, equivalents, and alternatives falling within the spirit and scope of the disclosure.

1. A method, comprising:
calculating, via an electronic device, location data related to a region in which the electronic device may operate;
determining, via the electronic device, the region in which the electronic device is currently operating within based on the location data; and
adjusting an output transmitting power of the electronic device to a predetermined power level at or below which to transmit one or more Long Term Evolution (LTE) transmission signals based at least in part on the region and one or more frequency operating parameters utilized by the electronic device, wherein the predetermined power level varies across frequency bandwidths of an LTE frequency band associated with the region, varies across frequency channels of the LTE frequency band associated with the region, or varies across the frequency bandwidths and the frequency channels associated with the region.

2. The method of claim 1, wherein calculating the location data comprises calculating the location based on received global positioning system (GPS) location data, web-based location data, or a combination thereof.

3. The method of claim 1, wherein determining the region in which the electronic device is currently operating within comprises determining a continent, a country, a territory, or a combination thereof, in which the electronic device is currently operating within.

4. The method of claim 1, wherein determining the region in which the electronic device is currently operating within comprises determining the frequency band associated with the region.

5. The method of claim 1, wherein determining the region in which the electronic device is currently operating within comprises determining the Long Term Evolution (LTE) frequency band associated with the region.

6. The method of claim 1, comprising adjusting the output transmitting power of the electronic device based on the region and a frequency carrier bandwidth of the frequency bandwidths as the one or more frequency operating parameters.

7. The method of claim 1, comprising adjusting the output transmitting power of the electronic device based on the region and a frequency channel of the frequency channels as the one or more frequency operating parameters.

8. The method of claim 1, wherein adjusting the output transmitting power of the electronic device based on the region and the one or more frequency operating parameters comprises reducing a power consumption of the electronic device.

9. A method, comprising:
receiving via a processor of an electronic device an input to activate the electronic device;
receiving location data;
determining a physical region in which the electronic device is located based at least in part on the location data; and
determining a transmitting power as a predetermined power level at or below which to transmit at least one Long Term Evolution (LTE) transmission signal from the electronic device based at least in part on a frequency band corresponding to the physical region and one or more frequency operating parameters utilized by the electronic device, wherein the predetermined power level varies across frequency bandwidths of an LTE frequency band associated with the region, varies across frequency channels of the LTE frequency band associated with the region, or varies across the frequency bandwidths and the frequency channels associated with the region.

10. The method of claim 9, wherein determining the transmitting power of the electronic device comprises determining the transmitting power based on the Long Term Evolution (LTE) frequency band designated for a specific continent, a specific country, a specific territory, or a combination thereof, as the physical region.

11. The method of claim 9, wherein determining the transmitting power of the electronic device comprises determining the transmitting power based on a Long Term Evolution (LTE) frequency bandwidth of the frequency bandwidths as the one or more frequency operating parameters.

12. The method of claim 11, wherein determining the transmitting power of the electronic device comprises determining the transmitting power based on a frequency channel of the frequency channels of the LTE frequency bandwidth being utilized by the electronic device.

13. The method of claim 9, comprising determining the transmitting power of the electronic device based on [[a]] the Long Term Evolution (LTE) frequency band, an LTE frequency bandwidth of the frequency bandwidths, and a frequency channel of the frequency channels of the LTE frequency bandwidth.

14. An electronic device, comprising:
a network interface configured to allow the electronic device to communicate over one or more channels of a wireless network; and
a transmitter configured to transmit data over the one or more channels, wherein the transmitter comprises one or more processors configured to:
cause the transmitter to transmit one or more Long Term Evolution (LTE) transmission signals at or below a first predetermined output transmitting power magnitude as a predetermined power level based on a first frequency band of a first region in which the electronic device is located and based on a first frequency bandwidth for the wireless network; and
cause the transmitter to transmit one or more Long Term Evolution (LTE) transmission signals at or below a second predetermined output transmitting power magnitude as the predetermined power level based on the first frequency band and based on a second frequency bandwidth for the wireless network, wherein the predetermined power level varies across frequency bandwidths of the LTE frequency band associated with the first region, varies across frequency channels of the LTE frequency band associated with the first region, or varies across the frequency bandwidths and the frequency channels associated with the first region.

15. The electronic device of claim 14, wherein the wireless network comprises a Long Term Evolution (LTE) wireless network.

16. The electronic device of claim 14, wherein the one or more processors are configured to:
cause the transmitter to transmit one or more Long Term Evolution (LTE) transmission signals at or below a third output transmitting power magnitude as the predetermined power level based on a second frequency band of a second region in which the electronic device is located and based on the first frequency bandwidth; and
cause the transmitter to transmit one or more Long Term Evolution (LTE) transmission signals at or below a fourth output transmitting power magnitude as the predetermined power level based on the second frequency band and based on the second frequency bandwidth.

17. The electronic device of claim 14, wherein the one or more processors are configured to:
cause the transmitter to transmit at or below the first output transmitting power magnitude as the predetermined power level based on the first frequency band and based on a first frequency channel for the wireless network; and
cause the transmitter to transmit at or below the second output transmitting power magnitude as the predetermined power level based on the first frequency band and a second frequency channel for the wireless network.

18. The electronic device of claim 17, wherein the one or more processors are configured to:
cause the transmitter to transmit at or below a third output transmitting power magnitude as the predetermined power level based on a second frequency band of a second region in which the electronic device is located and the first frequency channel; and
cause the transmitter to transmit at or below a fourth output transmitting power magnitude as the predetermined power level based on the second frequency band and the second frequency channel.

19. A non-transitory computer-readable medium having computer executable code stored thereon, the code comprising instructions to:
cause a processor of an electronic device to calculate location data;
cause the processor to determine a region in which the electronic device is currently operating within based on the location data; and
cause the processor to vary an output transmitting power as a predetermined power level of the electronic device between at least two predetermined power levels at or below which to transmit one or more Long Term Evolution (LTE) transmission signals based at least in part on the region and a frequency operating parameter currently being utilized by the electronic device, wherein the predetermined power level varies across frequency bandwidths of an LTE frequency band associated with the region, varies across frequency channels of the LTE frequency band associated with the region, or varies across the frequency bandwidths and the frequency channels associated with the region.

20. The non-transitory computer-readable medium of claim 19, wherein the code comprises instructions to vary the output transmitting power of the electronic device based on the region and a Long Term Evolution (LTE) frequency bandwidth as the frequency operating parameter.

21. The non-transitory computer-readable medium of claim 19, wherein the code comprises instructions to vary the output transmitting power of the electronic device based on the region and a Long Term Evolution (LTE) frequency channel as the frequency operating parameter.

22. The non-transitory computer-readable medium of claim 19, wherein the code comprises instructions to cause the processor to vary the output transmitting power of the electronic device based on the region and the frequency operating parameter to reduce a power consumption of the electronic device and to increase an efficiency of a transmitter of the electronic device.

23. A wireless electronic device, comprising:
one or more processors configured to:
receive location data;
determine a Long Term Evolution (LTE) coverage region in which the wireless electronic device is currently operating within based on the location data; and
cause a transmitter of the wireless electronic device to generate a predetermined output transmitting power level as a predetermined power level at or below which to transmit one or more Long Term Evolution (LTE) transmission signals based at least in part on the LTE coverage region, a frequency bandwidth, and one or more frequency channels associated with the frequency bandwidth being utilized by the wireless electronic device, wherein the predetermined power level varies across frequency bandwidths of an LTE frequency band associated with the region, varies across frequency channels of the LTE frequency band associated with the region, or varies across the frequency bandwidths and the frequency channels associated with the region.

24. The wireless electronic device of claim 23, wherein the one or more processors are configured to cause the transmitter to transmit the one or more Long Term Evolution (LTE) transmission signals at or below the output transmitting power level over an LTE network.
